(19) United States
(12) Patent Application Publication
(10) Pub. No.: US 2009/0295594 A1
(43) Pub. Date: Dec. 3, 2009

(54) DEMAND RESPONSE METHOD AND SYSTEM

(75) Inventor: YongTae YOON, Seoul (KR)

Correspondence Address: LANDO & ANASTASI, LLP, ONE MAIN STREET, SUITE 1100, CAMBRIDGE, MA, 02142, US

(73) Assignee: SNU R&DB FOUNDATION, Seoul (KR)

(21) Appl. No.: 12/476,617

(22) Filed: Jun. 2, 2009

(30) Foreign Application Priority Data
Jun. 3, 2008 (KR) 10-2008-0052283

(51) Int. Cl. G08B 5/22; G06Q 10/00

(52) U.S. Cl. 340/825.36; 705/10

(57) ABSTRACT

Provided are a demand response method and system. A household demand response apparatus includes: a signal reception unit which receives a critical peak notification message; a display unit which displays the received critical peak notification message and displays an inquiry message inquiring whether to interrupt power supply during a time section in which a critical peak occurs; and a control unit which controls the power supply based on a response to the inquiry message.

This application claims priority from Korean Patent Application No. 10-2008-0052283 filed on Jun. 3, 2008 in the Korean Intellectual Property Office, the disclosure of which is incorporated herein by reference in its entirety.

### BACKGROUND OF THE INVENTION

1. Field of the Invention

The present invention relates to demand response, and more particularly, to a method and system which can achieve more efficient demand response by dynamically implementing a critical peak pricing (CPP) program.

2. Description of the Related Art

Various demand response programs are being applied in order to manage the demand from users. Recently, a critical peak pricing (CPP) program has been introduced.

In the conventional CPP program, an energy service provider unilaterally determines when to generate a CPP event and set a CPP time section and applies the determination result. Therefore, users often have to pay unexpectedly high electric bills.

In addition, the energy service provider decides when to generate a CPP event based on electricity prices which are determined at regular time intervals (e.g., every six minutes) in a wholesale electricity market. Thus, when the energy service provider generates a CPP event since wholesale electricity prices are very high during a certain period of time, if a CPP time section set after the generation of the CPP event happens to be a period of very low demand, the generation of the CPP event may result in a reduction in the energy service provider's earnings.

The conventional CPP program does not allow the energy service provider to freely generate a CPP event within a predetermined number of times (e.g., three times a month) and set a CPP time section. Instead, once a CPP event is generated, three CPP time sections are automatically set at regular time intervals. Therefore, the energy service provider does not have flexibility in setting CPP time sections, which, in turn, reduces the usability of the conventional CPP program.

### SUMMARY OF THE INVENTION

Aspects of the present invention provide a method and system which can achieve more efficient demand response for both an energy service provider, who supplies electric power, and a user by dynamically implementing a critical peak pricing (CPP) program.

Aspects of the present invention also provide a method which enables a user to control a CPP event received from an energy service provider and thus more actively manage power demand in the user's house.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a household demand response apparatus including: a signal reception unit which receives a critical peak notification message; a display unit which displays the received critical peak notification message and displays an inquiry message inquiring whether to interrupt power supply during a time section in which a critical peak occurs; and a control unit which controls the power supply based on a response to the inquiry message.

According to another aspect of the present invention, there is provided a demand response method including: displaying a critical peak notification message; displaying an inquiry message inquiring whether to interrupt power supply during a time section in which a critical peak occurs; and controlling the power supply based on a response to the inquiry message.

According to another aspect of the present invention, there is provided an energy service provider system including: a price estimation unit which estimates an electricity price to be determined in an electricity market; a consumption pattern classification unit which provides power consumption pattern information of each user; a critical peak determination unit which determines an electricity price and when to generate a CPP event based on the estimated electricity price and the provided power consumption pattern information; and a demand response unit which transmits a CPP event signal based on the determination result of the critical peak determination unit.

According to another aspect of the present invention, there is provided a demand response system including: an energy service provider who transmits a CPP event signal based on a power consumption pattern of a user; and a household demand response apparatus which receives the CPP event signal, displays details of a CPP event, and controls power supply during a time section, in which a CPP rate is applied, based on the user's response.

### BRIEF DESCRIPTION OF THE DRAWINGS

The above and other aspects and features of the present invention will become more apparent by describing in detail exemplary embodiments thereof with reference to the attached drawings, in which:

FIG. 1 is a conceptual diagram for explaining a critical peak pricing (CPP) program according to the present invention;

FIG. 2 is a schematic conceptual diagram for explaining a method of determining a CPP time section according to an exemplary embodiment of the present invention;

FIG. 3 is an electricity price graph having a CPP time section according to an exemplary embodiment of the present invention;

FIG. 4 illustrates a demand response system according to an exemplary embodiment of the present invention;

FIG. 5 is a block diagram of the energy service provider illustrated in FIG. 4;

FIG. 6 is a block diagram of a household demand response apparatus illustrated in FIG. 4;

FIG. 7 shows a standby user interface provided by the household demand response apparatus according to an exemplary embodiment of the present invention;

FIG. 8 shows a customer information user interface provided by the household demand response apparatus according to an exemplary embodiment of the present invention;

FIG. 9 shows a critical peak details user interface provided by the household demand response apparatus according to an exemplary embodiment of the present invention;

FIGS. 10 and 11 show a critical peak reservation details user interface provided by the household demand response apparatus according to an exemplary embodiment of the present invention;

FIG. 12 shows a critical peak reservation user interface provided by the household demand response apparatus according to an exemplary embodiment of the present invention;

FIG. 13 shows a critical peak reservation completion user interface provided by the household demand response apparatus according to an exemplary embodiment of the present invention;

FIG. 14 shows a unit usage user interface provided by the household demand response apparatus according to an exemplary embodiment of the present invention;

FIG. 15 shows an accumulated usage user interface provided by the household demand response apparatus according to an exemplary embodiment of the present invention;

FIG. 16 shows an event notification user interface provided by the household demand response apparatus according to an exemplary embodiment of the present invention;

FIG. 17 shows a reservation notification message provided by the household demand response apparatus according to an exemplary embodiment of the present invention;

FIG. 18 shows a power supply interruption message provided by the household demand response apparatus according to an exemplary embodiment of the present invention;

FIG. 19 shows a power supply interruption cancellation message provided by the household demand response apparatus according to an exemplary embodiment of the present invention;

FIG. 20 is a flowchart illustrating a method of determining a CPP time section and an electricity price according to an exemplary embodiment of the present invention; and

FIGS. 21A through 21C are graphs illustrating representative consumption patterns which represent power consumption patterns of users according to an exemplary embodiment of the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification. As used herein, the term “and/or” includes any and all combinations of one or more of the associated listed items.

It will be understood that, although the terms first, second, third, etc., may be used herein to describe various elements, components and/or sections, these elements, components and/or sections should not be limited by these terms. These terms are only used to distinguish one element, component or section from another element, component or section. Thus, a first element, component or section discussed below could be termed a second element, component or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

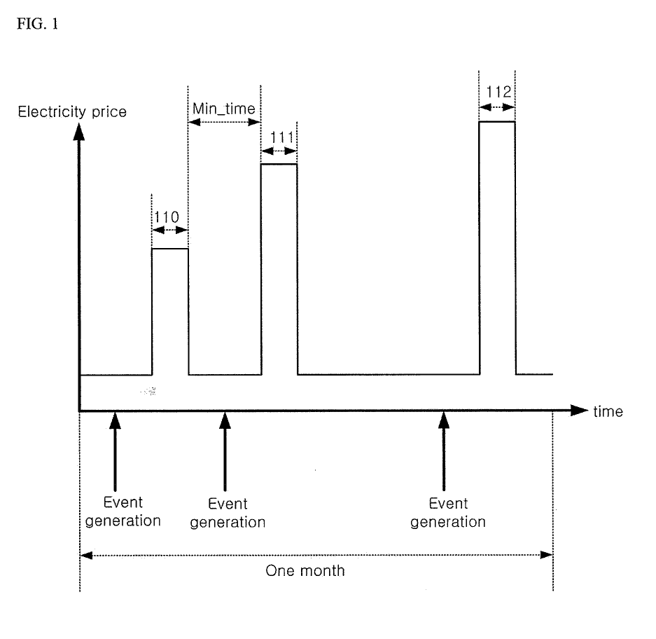

FIG. 1 is a conceptual diagram for explaining a critical peak pricing (CPP) program according to the present invention. Referring to FIG. 1, a power supplier may generate a CPP event, for example, three times a month. Once the CPP event is generated, a CPP time section 110, 111 or 112 appears after a predetermined period of time has elapsed from the generation of the CPP event.

The power supplier generates a CPP event to inform a user of when a CPP time section will appear. Accordingly, the user learns from the CPP event that relatively high electric bills will be charged for his or her power use during the CPP time section.

There are restrictions on the generation of the CPP event. That is, a CPP event may be generated a predetermined number of times (e.g., three times) during a predetermined period of time (e.g., a month). If a CPP event is generated more than the predetermined number of times, the user may process the generated CPP event as an event error.

Once a CPP time section is set after the generation of a CPP event, a minimum time interval (‘Min_time’ in FIG. 1) may be maintained between the termination of the CPP time section and the start of a next CPP time section.

In addition, the sum of CPP time sections set during a month may be limited to a predetermined period of time or less. For example, a total period of time during which a CPP rate can be applied may be limited to three days, i.e., 3×24=72 hours. In this case, the power supplier may freely set CPP time sections by appropriately distributing the 72 hours.

The power supplier generates a CPP event based on price fluctuations in a wholesale electricity market and the power consumption pattern of the user, which will be described later.

The user can interrupt the power supply from the power supplier during a CPP time section which is set after the generation of a CPP event. Therefore, the user can control power consumption in his or her house.

That is, the power supplier sets a CPP time section based on price fluctuations in the wholesale electricity market and the power consumption pattern of the user in order to charge high electric rates during the CPP time section and charge low electric rates during a non-CPP time section. In so doing, the power supplier can efficiently manage power demand. Unlike when using the conventional CPP program, the user can interrupt the power supply during a CPP time section when using the CPP program according to the present invention. Thus, the user can control power demand by himself or herself.

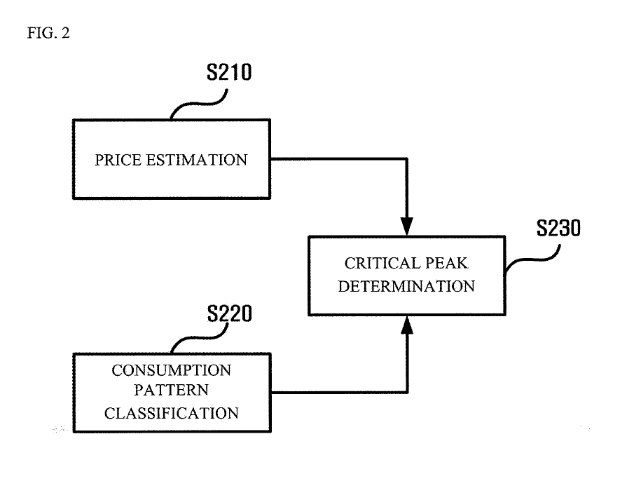

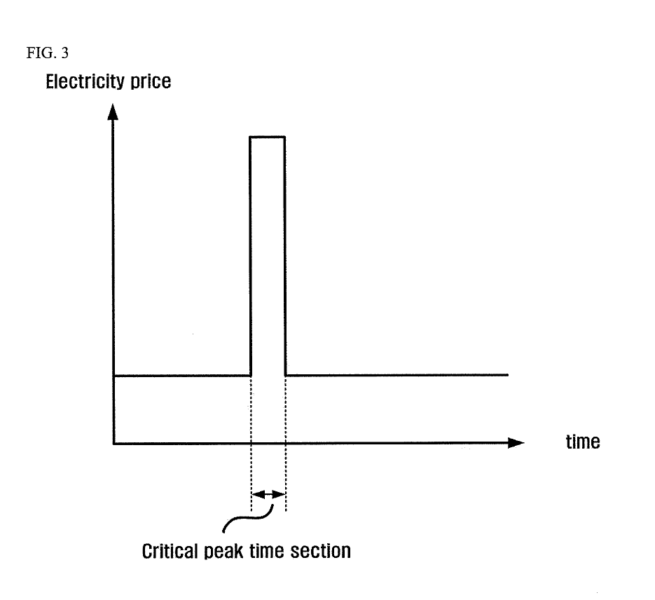

FIG. 2 is a schematic conceptual diagram for explaining a method of determining a CPP time section according to an exemplary embodiment of the present invention. Referring to FIG. 2, an electricity price is estimated based on various information received from the wholesale electricity market (operation S210). The power consumption pattern of each household is classified (operation S220). Then, a CPP time section and an electric rate for each power consumption pattern are determined based on the estimated electricity price and the classified consumption pattern (operation S230). An electricity price graph having a CPP time section may be as shown in FIG. 3.

Referring to FIG. 3, the electricity price graph according to the present invention may be configured to charge high electric rates during a predetermined period of time, that is, during a CPP time section and charge relatively low electric rates during a non-CPP time section. Here, the CPP time section may be determined based on the power consumption pattern of the user (operation S220), and an electric rate during the CPP time section may be determined based on the estimated electricity price (operation S210).

If the electric rate shown in FIG. 3 is applied, restrictions may be imposed. The restrictions may include the number of times that the CPP time section can be set during a predetermined period of time (e.g., three times in a month) and the duration of the CPP time section.

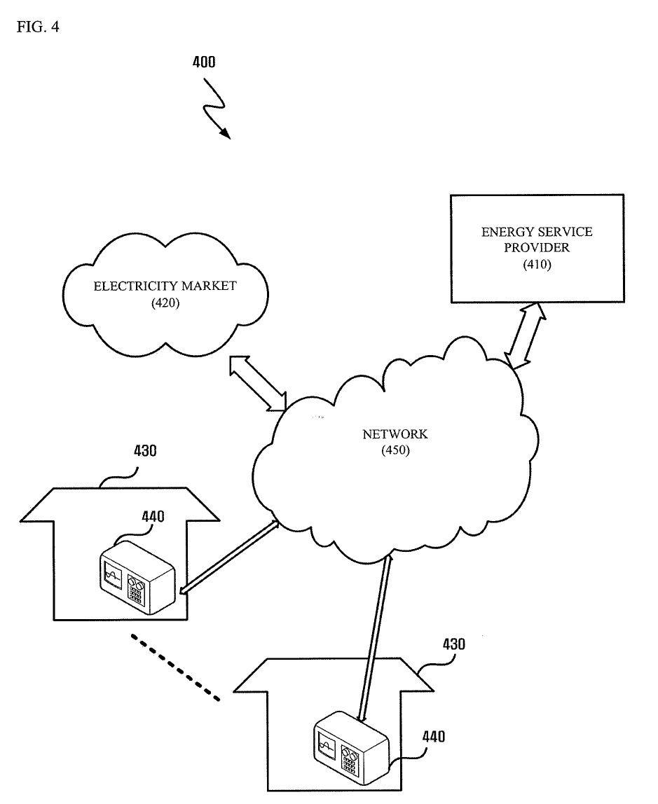

FIG. 4 illustrates a demand response system 400 according to an exemplary embodiment of the present invention. Referring to FIG. 4, the demand response system 400 according to the present embodiment may include an energy service provider 410, an electricity market 420, a user 430, and a network 450.

The energy service provider 410 not only produces power but also distributes the produced power. Therefore, it can be understood that the energy service provider 410 according to the present invention supplies power directly or indirectly to an end user, that is, the user 430.

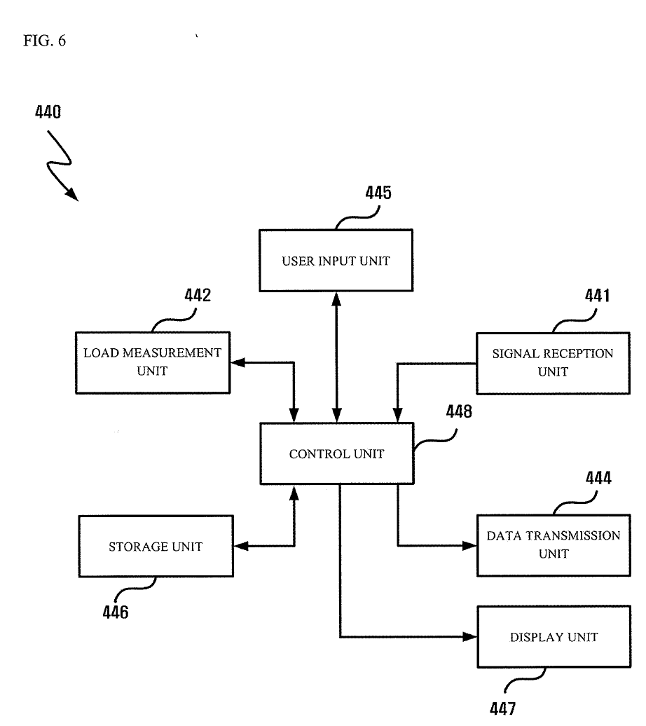

The user 430 receives electric power from the energy service provider 410 according to a CPP policy and consumes the received power. For ease of description, each household is defined as the user 430 in the present invention. The user 430 is equipped with a household demand response apparatus 440. The household demand response apparatus 440 will be described in detail later with reference to FIG. 6.

The energy service provider 410, the electricity market 420 and the user 430 may be connected to one another by the network 450 in order to exchange information required for demand response according to the present invention. The network 450 may be a wired network, a wireless network, or a combination of the same.

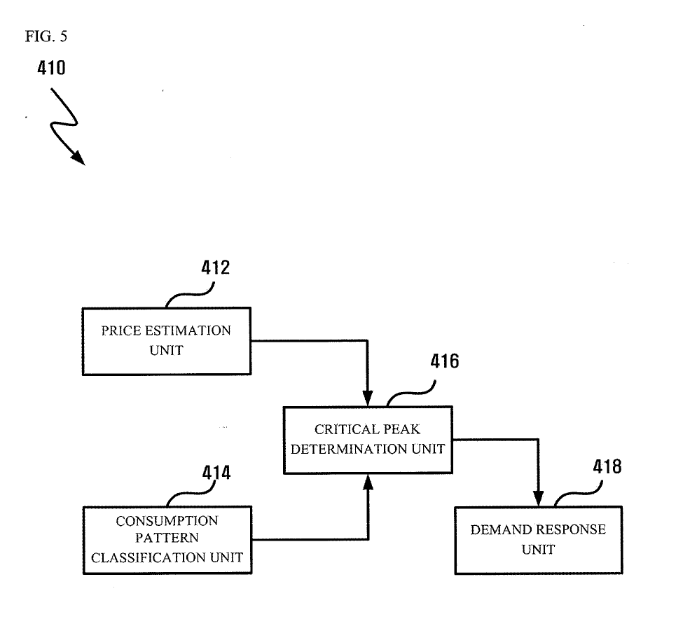

FIG. 5 is a block diagram of the energy service provider 410 illustrated in FIG. 4. Referring to FIG. 5, the energy service provider 410 includes a price estimation unit 412, a consumption pattern classification unit 414, a critical peak determination unit 416, and a demand response unit 418.

The price estimation unit 412 estimates an electricity price which is to be determined in the electricity market 420. To this end, the price estimation unit 412 must identify the relationship between power load and electricity price. Information regarding this relationship may be obtained from existing data. That is, the information regarding the load-price relationship for the same CPP time section in a certain region may be collected in order to identify the relationship between power load and electricity price.

Since price volatility is taken into consideration to estimate electricity prices, the reliability of the estimated prices can be enhanced. For price volatility-based estimation, a technique used in financial engineering to assess price volatility over time may be employed. Examples of the technique may include a random walk (Brownian motion) model, a mean reversion model, and a jump-diffusion with mean-reversion model.

The random walk model (the Brownian motion model or a Wiener process model) is a technique for estimating a price based on price drifts and volatility. As time elapses, electricity prices fluctuate more wildly. For example, the relationship between load and price may be defined by ln ρₙ=aLₙ+b, where ρₙ and Ln are price and load at a time step of n, respectively, and “a” is a slope indicating the relationship between load and price. In addition, “b” is a point of contact of a line.

Therefore, the relationship between load and price at successive time steps may be defined by ln ρₙ=ln ρₙ₋₁+a(Lₙ−Lₙ₋₁). If price volatility is reflected in the above equation, the above equation may be rearranged into ln ρₙ=ln ρₙ₋₁+a(Lₙ−Lₙ₋₁)+σ(Δt)^{1/2}, where σ(Δt)^{1/2} is a factor indicating price volatility.

In the mean reversion model, prices always tend to revert to a predetermined level and fluctuate within a predetermined range. That is, the mean reversion model determines a drift based on a mean reversion rate and a long-run mean. Based on the above-mentioned random walk model, the mean reversion model may be defined as ln ρₙ=ln ρₙ₋₁+a(Lₙ−Lₙ₋₁)+a (Lₙ−Lₙ₋₁)+a (Δt)^{1/2}. The long run mean, that is, a mean reversion level, is a value that the fluctuating price finally reaches.

The jump diffusion model takes price spikes into consideration. In the jump diffusion model, the frequency and size of price spikes are calculated based on previous prices and reflected in an estimated price.

The technique for estimating future electricity prices based on a history of previous loads and electricity prices in the electricity market is not limited to the above examples. In order to estimate electricity prices, the price estimation unit 412 according to the present invention may use any technique that can estimate future electricity prices based on the relationship between power load and electricity price.

The consumption pattern classification unit 414 classifies each user's power consumption pattern by category. A method used by the consumption pattern classification unit 414 to classify power consumption patterns will be described in detail later.

The critical peak determination unit 416 determines a CPP time section and an electric rate for each user based on an electricity price estimated by the price estimation unit 412 and a power consumption pattern classified by the consumption pattern classification unit 414.

The demand response unit 418 manages the power demand of each user based on the CPP time section and the electric rate determined by the critical peak determination unit 416. In particular, the demand response unit 418 transmits a signal to each user in order to inform each user of a CPP time section. In so doing, the demand response unit 418 generates a CPP event.

In addition, the demand response unit 418 may collect information regarding, for example, the amount of electricity consumed by each user and an hourly electric rate. The demand response unit 418 may charge each user based on the collected information. The demand response unit 418 may also store and manage a history of CPP events generated for each user and the power consumption status after the generation of a CPP event.

FIG. 6 is a block diagram of the household demand response apparatus 440 illustrated in FIG. 4. Referring to FIG. 6, the household demand response apparatus 440 includes a signal reception unit 441, a load measurement unit 442, a data transmission unit .444, a user input unit 445, a storage unit 446, a display unit 447, and a control unit 448.

The signal reception unit 441 receives from the energy service provider 410 a signal notifying the generation of a CPP event and various information required to operate the household demand response apparatus 440.

The load measurement unit 442 measures the amount of electric power consumed by a corresponding household at regular time intervals.

The storage unit 446 stores information regarding the user 430 who possesses the household demand response apparatus 440. The information regarding the user 430 corresponds to customer information from a point of view of the energy service provider 410, and the customer information may include pricing program information and customer classification information.

The pricing program information may include the number of times that a CPP event is generated, a cycle at which the CPP event is generated, and the duration of the CPP event. The customer classification information may include information indicating to which of the consumption patterns classified by the energy service provider 410 the consumption pattern of the user 430 corresponds.

The storage unit 446 may further store customer identification information that is used by the energy service provider 410 to identify the user 430. The customer identification information according to the present invention may be any information which can be used to identify the user 430.

The data transmission unit 444 transmits information regarding the amount of power consumption measured by the load measurement unit 442 or various customer information stored in the storage unit 446 to the energy service provider 410.

The display unit 447 visually represents the amount of power consumption measured by the load measurement unit 442 or electric rates according to the amount of power consumption.

The user input unit 445 provides an interface by which the user 430 can input the customer identification information or select information displayed on the display unit 447. The interface may be a keypad, a keyboard, a joystick, a touch pad, or buttons. In particular, the user input unit 445 may be integrated with the display unit 447 and may be configured in the form of a touch screen. The control unit 448 controls each component of the household demand response apparatus 440.

When the signal reception unit 441 receives a signal from the energy service provider 410, the user 430 may interrupt the power supply to his or her house during a CPP time section in order to save electricity costs. However, in some cases, the user 430 may feel the need not to interrupt the power supply. That is, the user 430 may be in a situation where electric power must be supplied during the CPP time section even through high electric rates are applied during the CPP time section.

Therefore, the user 430 may input reservation information to the household demand response apparatus 440 by using the user input unit 445. The reservation information may include information indicating a time section during which power must be supplied. For example, if power must be supplied to the house of the user 430 from 6 p.m. on Apr. 1, 2008 to 6 p.m. on Apr. 2, 2008, the user 430 may input the time section from 6 p.m. on Apr. 1, 2008 to 6 p.m. on Apr. 2, 2008 as the reservation information by using the user input unit 445.

The input reservation information may be stored in the storage unit 446. Upon confirming that the signal reception unit 441 has received a signal, the control unit 448 may not interrupt the power supply during a CPP time section based on the input reservation information.

In another embodiment, the control unit 448 may interrupt the power supply to the house of the user 430 during the CPP time section based on the reservation information. That is, the reservation information may serve as control information used to interrupt the power supply to the house of the user 430 during the CPP time section.

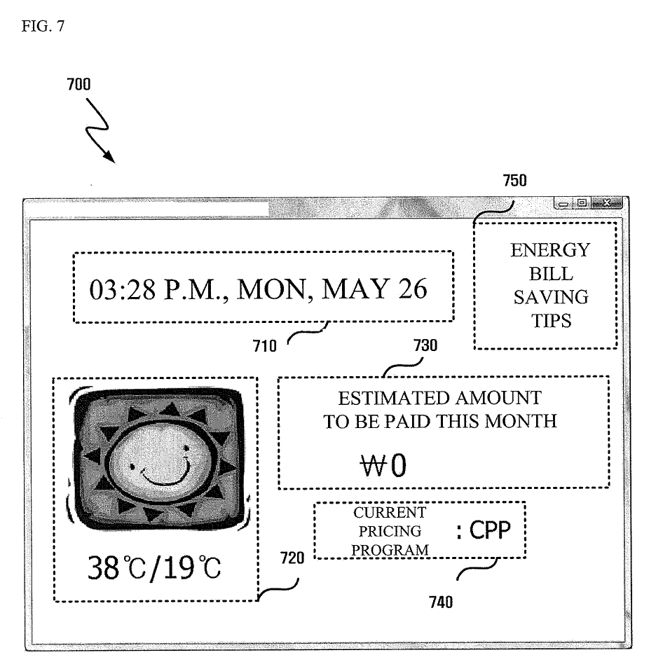

FIG. 7 shows a standby user interface 700 provided by the household demand response apparatus 440 according to an exemplary embodiment of the present invention. Referring to FIG. 7, the standby user interface 700 is provided by the display unit 447 under the control of the control unit 448 and may be understood as a default screen provided by the household demand response apparatus 440.

The standby user interface 700 may include a time information region 710, a weather information region 720, an estimated amount information region 730, a pricing program information region 740, and additional information region 750.

The time information region 710 may show current date and time. The time information region 710 may show the system time of the household demand response apparatus 440. In this case, the system time of the household demand response apparatus 440 may be synchronized with that of the energy service provider 410. To this end, the energy service provider 410 may periodically check the system time of the household demand response apparatus 440 and synchronize its system time with that of the household demand response apparatus 440.

The weather information region 720 may show the lowest and highest temperature information of the day and a weather image corresponding to the weather of the day from among a plurality of weather images. The weather information region 720 may be provided by the energy service provider 410 via the signal reception unit 441.

The estimated amount information region 730 may show an estimated amount that the user 430 will pay this month for his or her electricity use or an estimated amount for electric power consumed until the previous day of the current month. The estimated amount information may be provided by the energy service provider 410 via the signal reception unit 441.

The pricing program information region 740 shows a current pricing program that the user 430 uses based on the pricing program information stored in the storage unit 446. In another embodiment, the pricing program information may be provided by the energy service provider 410 via the signal reception unit 441.

The additional information region 750 may show information useful for the user 430, such as energy bill saving tips. The user 430 may obtain basic information, such as the estimated amount and the current pricing program, from the standby user interface 700.

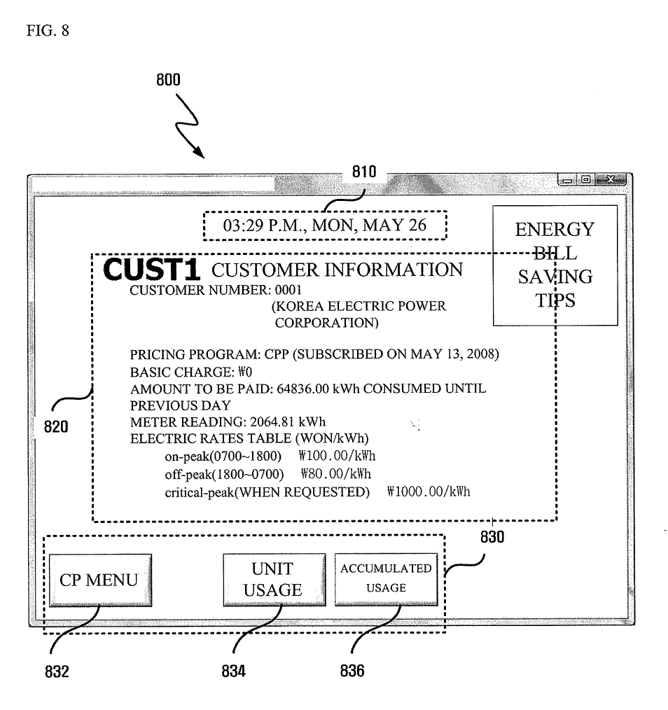

When the user 430 touches the standby user interface 700 or inputs information to the standby user interface 700 by using the user input unit 445, the standby user interface 700 is changed to a customer information user interface 800 shown in FIG. 8.

Referring to FIG. 8, the customer information user interface 800 includes a time information region 810, a customer information region 820, and a user control region 830. The time information region 810 corresponds to the time information region 710 shown in FIG. 7.

The customer information region 820 shows information regarding the user 430 who uses the household demand response apparatus 440. Examples of the information may include customer name (“CUST1”), customer number, i.e., customer identification information (“0001”), the name of the energy service provider 410 (“Korea Electric Power Corporation”), pricing program information (“CPP”), pricing program subscription date (“May 13, 2008”), basic charge (“ [symbol] 0”), amount to be paid (“ [symbol] 74400”), amount of electricity consumed (“64836.00 kWh consumed until the previous day”), meter reading (“2064.81 kWh”), and electric rates table. The meter reading shown in FIG. 8 denotes the amount of electricity which was consumed until the previous day of the current month and which was measured by the load measurement unit 442 of the household demand response apparatus 440. From among the customer information shown in FIG. 8, components excluding the meter reading may be provided by the energy service provider 410.

The user control region 830 displays menus that the user 430 can control by using the user input unit 445. The user control region 830 includes a critical peak menu 832, a unit usage menu 834, and an accumulated usage menu 836.

The critical peak menu 832 may provide a function for retrieving critical peak details or CPP event reservation details and a function for critical peak reservation.

The unit usage menu 834 provides a unit usage graph screen, and the accumulated usage menu 836 provides an accumulated usage graph screen.

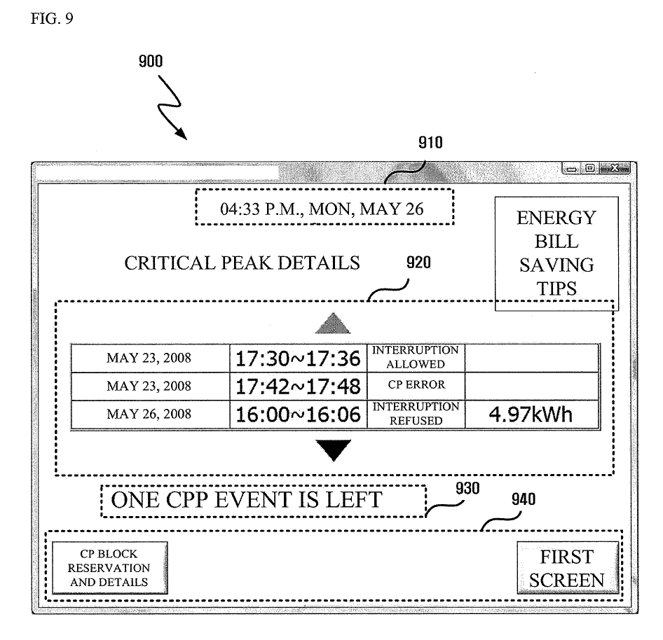

When the user 430 selects the critical peak menu 832, a critical peak details user interface 900 is provided as shown in FIG. 9.

Referring to FIG. 9, the critical peak details user interface 900 includes a time information region 910, a critical peak details list region 920, a message region 930, and a user control region 940.

The time information region 910 corresponds to the time information region 710 of FIG. 7.

The critical peak details list region 920 displays details of executions performed at the choice of the user 430 after a CPP event was generated. The execution details (such as the date and time when a CPP event was generated, the choice of the user 430, and the amount of power consumed during a CPP time section) shown in FIG. 9 may be provided by the energy service provider 410.

The user 430 may view previous data by clicking on an ‘Up’ button provided in the critical peak details list region 920. If the previous data is not available, the ‘Up’ button is disabled. The user 430 may also view subsequent data by clicking on a ‘Down’ button. If the subsequent data is not available, the ‘Down’ button is disabled.

The message region 930 displays a message informing how many CPP events to be generated are left. For example, if a CPP event has been generated twice until now when the number of times that the CPP event can be generated is limited to three times a month, a message saying, “One CPP event is left”, is displayed in the message region 930 as shown in FIG. 9.

The user control region 940 may include a menu for reserving a CPP event or retrieving CPP event reservation details or a menu for returning to a first screen. Here, the first screen may be the standby user interface 700 of FIG. 7 or the customer information user interface 800 of FIG. 8.

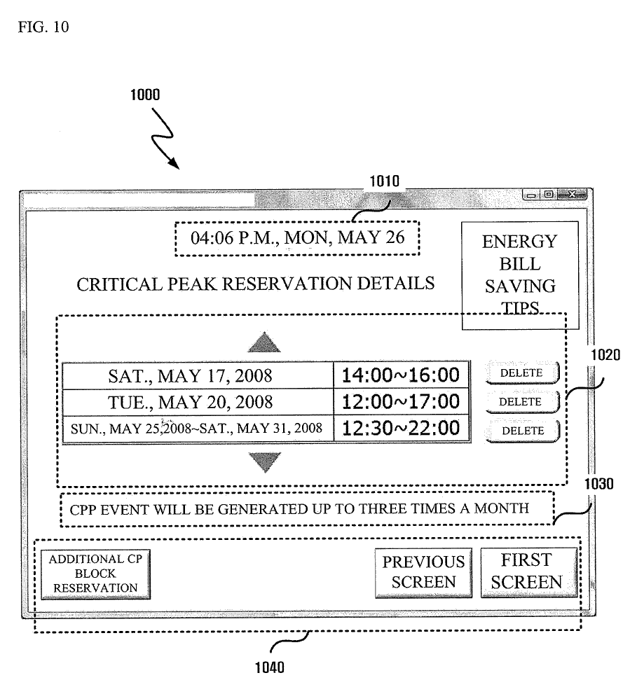

When the user 430 selects a “critical peak block reservation and details” menu in the user control region 940, the display unit 447 may provide a critical peak reservation details user interface 1000 as shown in FIG. 10.

Referring to FIG. 10, the critical peak reservation details user interface 1000 includes a time information region 1010, a critical peak reservation details list region 1020, a message region 1030, and a user control region 1040.

The time information region 1010 corresponds to the time information region 710 of FIG. 7.

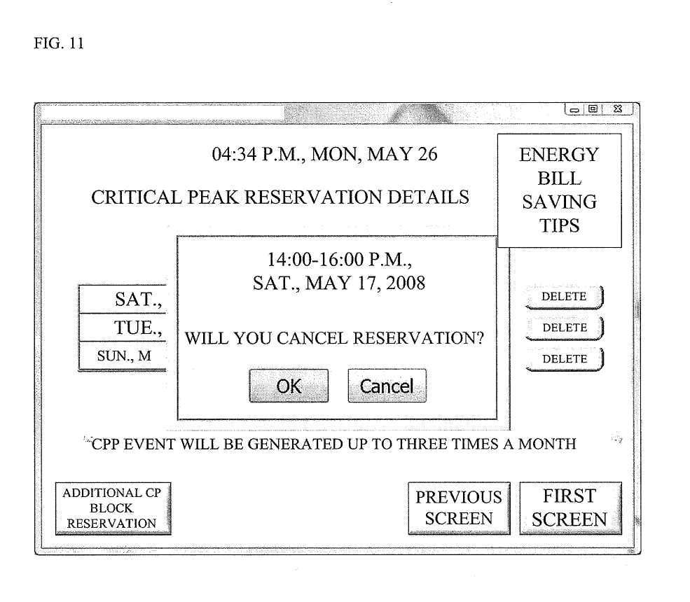

The critical peak reservation details list region 1020 displays CPP event reservation details registered by the user 430 through the user input unit 445. Here, reservation details (such as the date and time reserved for CPP event blockage) shown in FIG. 10 may be extracted from the storage unit 446 of the household demand response apparatus 440 and displayed accordingly. In addition, the critical peak reservation details list region 1020 may provide a function for deleting reservation details. If the user 430 clicks on a first ‘Delete’ button shown in FIG. 10, a message inquiring whether to delete corresponding reservation details is displayed as shown in FIG. 11. If the user 430 clicks on ‘OK’, the reservation details are deleted.

The user 430 may view previous data by clicking on the ‘Up’ button provided in the critical peak details list region 920. If the previous data is not available, the ‘Up’ button is disabled. The user 430 may also view subsequent data by clicking on the ‘Down’ button. If the subsequent data is not available, the ‘Down’ button is disabled.

The message region 1030 displays a message informing how many times a CPP event will be generated. For example, if the CPP event is to be generated three times a month, a message saying, “CPP event will be generated up to three times a month,” is displayed as shown in FIG. 10.

The user control region 1040 may include a menu for making an additional reservation for CPP event and a menu for returning to a first screen or a previous screen. The first screen may be the standby user interface 700 of FIG. 7 or the customer information user interface 800 of FIG. 8, and the previous screen may be the critical peak details user interface 900 of FIG. 9.

If the time displayed in the critical peak reservation details list region 1020 is included in a CPP time section set after a CPP event was generated, the power supply to the house of the user 430 is not interrupted.

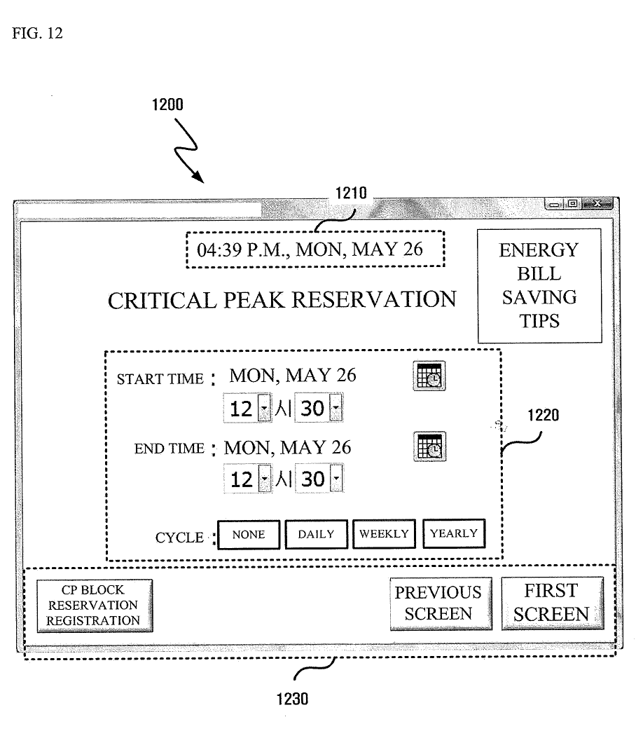

If the user 430 selects an ‘additional critical peak block reservation’ menu in the user control region 1040, the display unit 447 may provide a critical peak reservation user interface 1200 shown in FIG. 12.

Referring to FIG. 12, the critical peak reservation user interface 1200 includes a time information region 1210, a critical peak reservation setting region 1220, and a user control region 1230.

The time information region 1210 corresponds to the time information region 710 of FIG. 7.

The critical peak reservation setting region 1220 provides an interface by which the user 430 can set the critical peak reservation date and time by using the user input unit 445.

The user 430 may set critical peak reservation setting information (date, start time, end time, cycle, and the like) shown in FIG. 12 by using various forms of interfaces. For example, the user 430 may set ‘start time’ to ‘12:30 p.m., Monday, May 26’, ‘end time’ to ‘13:30 p.m., Monday, May 26’, and ‘cycle’ to ‘none’. In this case, if the signal reception unit 441 receives from the energy service provider 410 a signal informing that a CPP rate will be applied during the above time period, the control unit 448 prevents the power supply to the house of the user 430 from being interrupted between 12:30 p.m., Monday, May 26 and 13:30 p.m., Monday, May 26.

In the above situation, if the user 430 sets ‘cycle’ to ‘everyday’, the control unit 448 allows power to be continuously supplied to the house of the user 430 between 12:30 p.m. and 13:30 p.m. everyday from May 26.

The user control region 1230 may include a menu for registering a critical peak reservation or a menu for returning to a first screen or a previous screen. In this case, the first screen may be the standby user interface 700 of FIG. 7 or the customer information user interface 800 of FIG. 8, and the previous screen may be the critical peak reservation details user interface 1000 of FIG. 10.

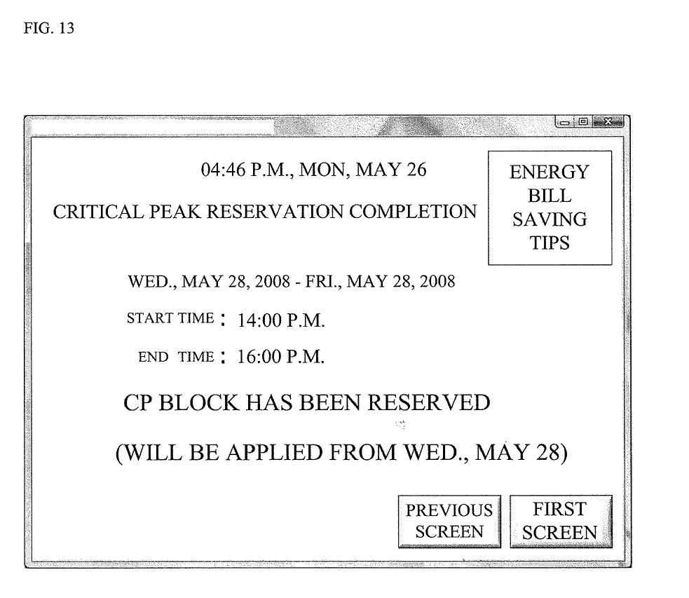

When the user 430 selects a ‘critical peak block reservation registration’ menu in the user control region 1230, a critical peak reservation completion user interface 1300 may be provided as shown in FIG. 13.

Referring to FIG. 13, the critical peak reservation completion user interface 1300 displays information indicating that critical peak has been reserved to allow power to be supplied to the house of the user 430 between 14:00 p.m. and 16:00 p.m. from Wednesday May 28, 2008 to Friday May 30, 2008, irrespective of a CPP event. The term ‘block’ shown in FIG. 13 denotes preventing the power supply to a house from being interrupted and will be understood as such throughout the specification.

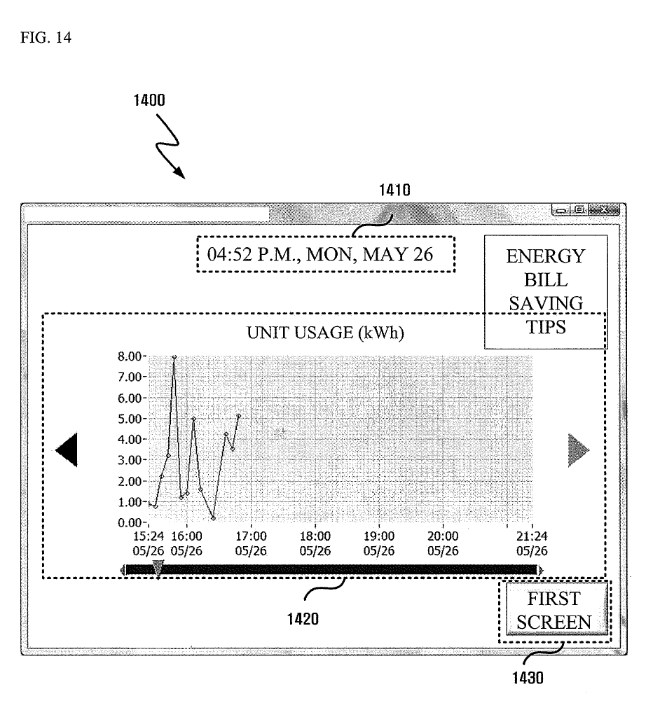

FIG. 14 shows a unit usage user interface 1400 which is displayed when the unit usage menu 834 in the user control region 830 of the customer information user interface 800 is selected.

Referring to FIG. 14, the unit usage user interface 1400 includes a time information region 1410, a unit usage information display region 1420, and a user control region 1430. The time information region 1410 corresponds to the time information region 710 of FIG. 7.

The unit usage information display region 1420 may represent a unit usage of effective power on a graph based on the amount of power consumption which was measured by the load measurement unit 442 at absolute time intervals (e.g., six minutes). Data for one day may be displayed in the unit usage information display region 1420.

The user 430 may view data for a previous date, which is represented on a graph, by clicking on a ‘Left’ button provided in the unit usage information display region 1420. The unit usage information display region 1420 may be designed to provide data for up to 6 months. If no previous data is available, the ‘Left’ button is disabled. In addition, the user 430 may view data for a subsequent date, which is represented on a graph, by clicking on a ‘Right’ button. If no subsequent data is available, the ‘Right’ button is disabled. The user 430 may view data for a desired time by moving a ‘Scroll’ bar.

The user control region 1430 may include a menu for returning to a first screen. The first screen may be the standby user interface 700 of FIG. 7 or the customer information user interface 800 of FIG. 8.

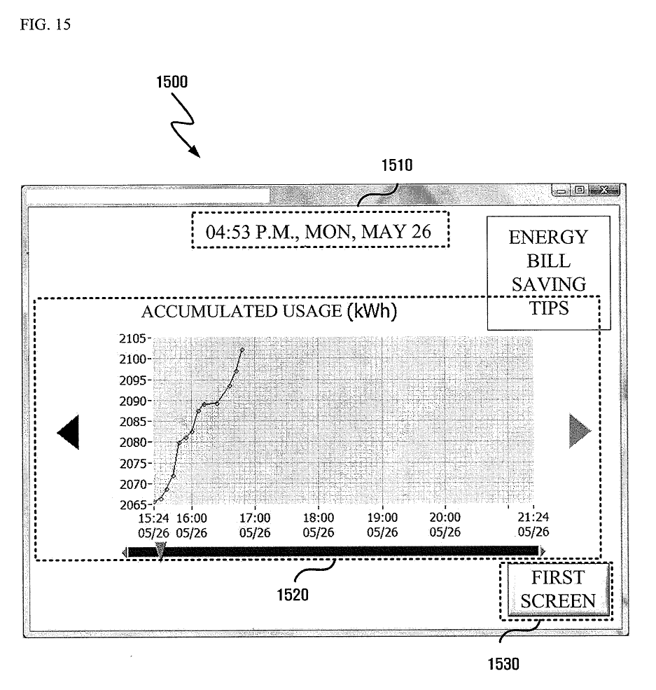

FIG. 15 shows an accumulated usage user interface 1500 which is displayed when the accumulated usage menu 836 in the user control region 830 of the customer information user interface 800 of FIG. 8 is selected.

Referring to FIG. 15, the accumulated usage user interface 1500 includes a time information region 1510, an accumulated usage information display region 1520, and a user control region 1530. The time information region 1510 corresponds to the time information region 710 of FIG. 7.

The accumulated usage information display region 1520 may represent an accumulated usage of effective power on a graph based on the amount of power consumption which was measured by the load measurement unit 442 at absolute time intervals (e.g., six minutes). Data for one day may be displayed in the accumulated usage information display region 1520.

The user 430 may view data for a previous date, which is represented on a graph, by clicking on a ‘Left’ button provided in the accumulated usage information display region 1520. The accumulated usage information display region 1520 may be designed to provide data for up to 6 months. If no previous data is available, the ‘Left’ button is disabled. In addition, the user 430 may view data for a subsequent date, which is represented on a graph, by clicking on a ‘Right’ button. If no subsequent data is available, the ‘Right’ button is disabled. The user 430 may view data for a desired time by moving a ‘Scroll’ bar.

The user control region 1530 may include a menu for returning to a first screen. The first screen may be the standby user interface 700 of FIG. 7 or the customer information user interface 800 of FIG. 8.

When the energy service provider 410 generates a CPP event, the signal reception unit 441 of the household demand response apparatus 440 receives an event signal and transmits the received event signal to the control unit 448.

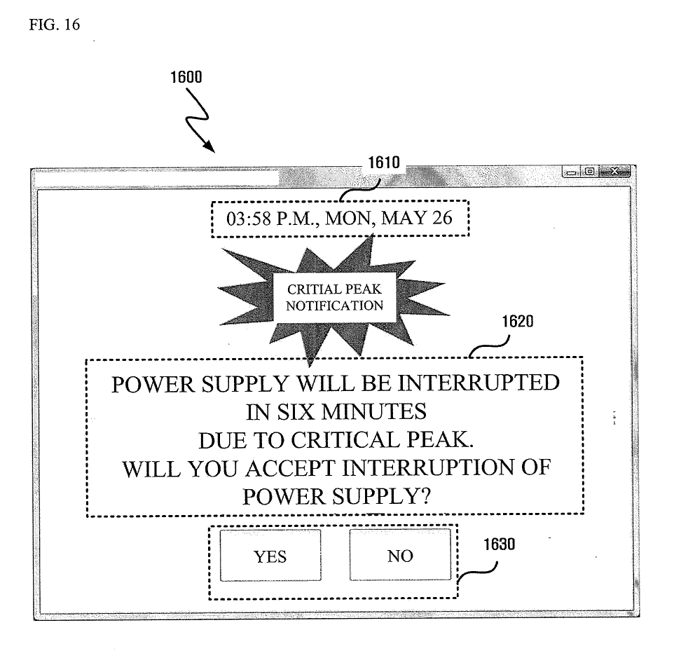

The control unit 448 provides an event notification user interface 1600, which displays details of a CPP event, on the display unit 448 as shown in FIG. 16. That is, when a CPP event is generated, the standby user interface 700 of FIG. 7 is changed to the event notification user interface 1600.

The event notification user interface 1600 includes a time information region 1610, a critical peak notification display region 1620, and a user control region 1630. The time information region 1610 corresponds to the time information region 710 of FIG. 7.

The critical peak notification display region 1620 displays when the CPP rate is applied and a message inquiring whether to interrupt the power supply in order to avoid the CPP rate.

The user control region 1630 provides an interface by which the user 430 can allow the interruption of power supply in order to avoid the CPP rate or refuse the interruption of power supply even if the CPP rate is applied during a certain period of time. For example, the user 430 may allow the interruption of power supply by clicking on ‘Yes’ in the user control region 1630. In addition, the user 430 may refuse the interruption of power supply by clicking on ‘No’ in the user control region 1630.

If the user 430 fails to input information regarding whether to allow or refuse the interruption of power supply within a given period of time, there may automatically be set as if the user 430 allowed the interruption of power supply.

The household demand response apparatus 440 may include additional components to interrupt the power supply to the house of the user 430 under the control of the control unit 448. The household demand response apparatus 440 may interrupt the power supply to all or some of electronic devices in the house of the user 430.

When the user 430 is not inside the house, the user 430 may fail to recognize the generation of a CPP event. Therefore, a wireless interface module (not shown) may be loaded into the household demand response apparatus 440, and the control unit 448 may control the wireless interface module to transmit a CPP event generation message to a mobile terminal of the user 430. Here, the user 430 may decide whether to allow the interruption of power supply to the house by using an input unit which is loaded into the mobile terminal.

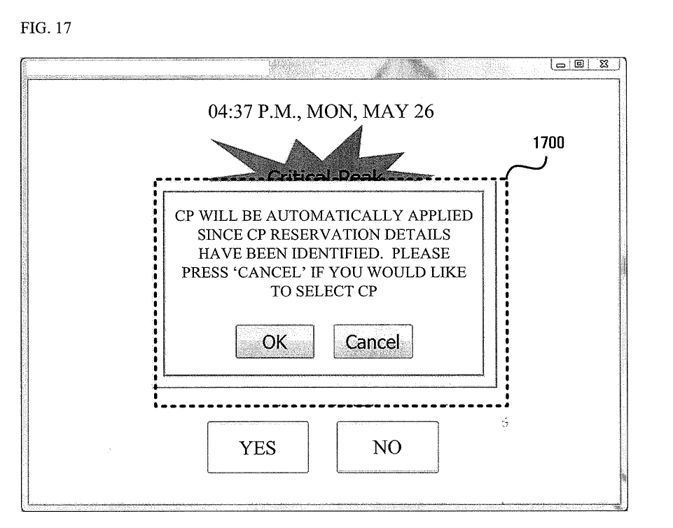

Referring to FIG. 16, when receiving the CPP event generation signal, the control unit 448 identifies CPP event reservation details stored in the storage unit 446. If a CPP time section set after the generation of a CPP event is included in the identified CPP event reservation details, a message 1700 informing that the CPP event has already been reserved is displayed as shown in FIG. 17, so that the user 430 can decide whether to interrupt power supply. For example, if the user 430 selects ‘OK’, power supply is not interrupted during the reserved CPP time section. If the user 430 selects ‘Cancel’, the above reservation is ignored, and the current screen returns to the event notification user interface 1600 of FIG. 16.

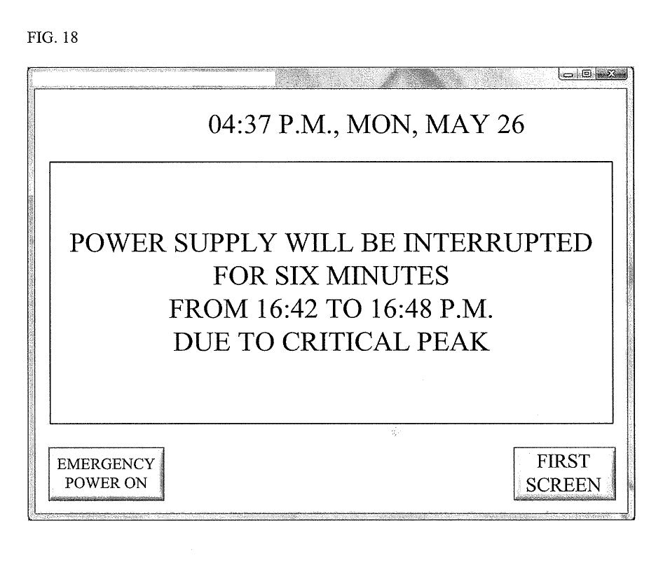

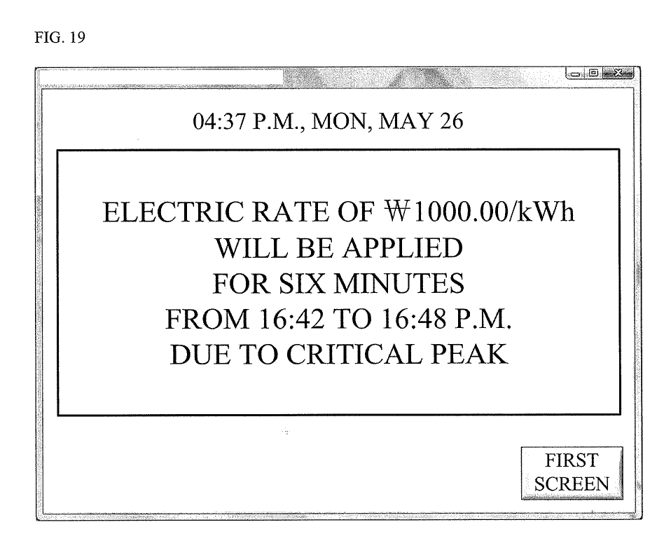

When the user 430 clicks on the ‘Yes’ button in the user control region 1630 of the event notification user interface 1600 of FIG. 16, a message informing that power supply will be interrupted during the CPP time section set after the generation of the CPP event is displayed as shown in FIG. 18.

In some cases, power supply that has been interrupted may need to be resumed. For these cases, a function for canceling the interruption of power supply may be provided. An ‘emergency power ON’ button shown in FIG. 18 provides this function.

When the user 430 clicks on the ‘No’ button in the user control region 1630 of the event notification user interface 1600 of FIG. 16, the ‘OK’ button in the message 1700 of FIG. 17, or the ‘emergency power ON’ button of FIG. 18, a message informing which electric rate will be applied for electric power consumed during the CPP time section which is set after the generation of the CPP event.

As described above, the CPP program according to the present invention has the following restrictions. That is, there is a limit to the number of times that a CPP event can be generated during a predetermined period of time. In addition, after a CPP time section is set, a minimum time interval must be inserted before a next CPP time section. If a CPP event is generated without complying with the above restrictions, the control unit 448 processes the generated CPP event as an event error.

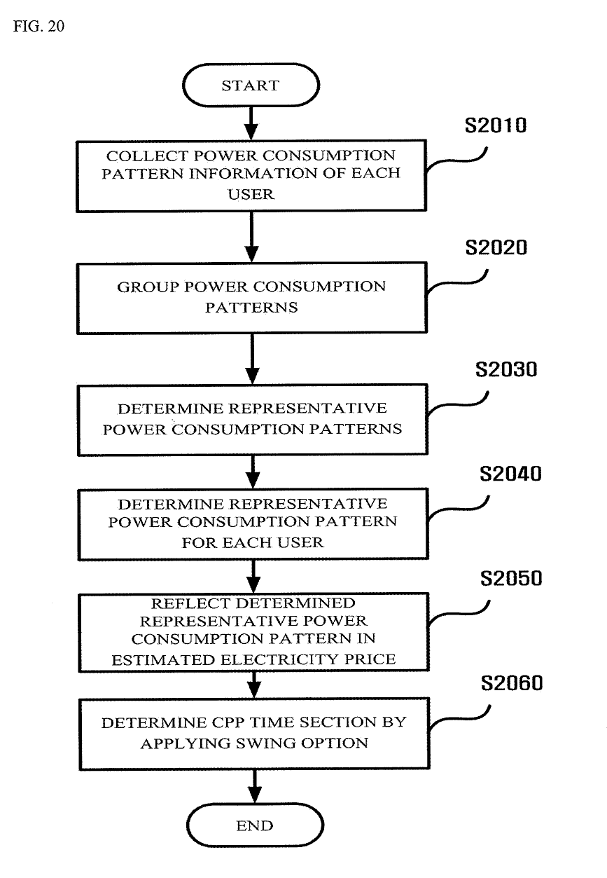

FIG. 20 is a flowchart illustrating a method of determining a CPP time section and an electricity price according to an exemplary embodiment of the present invention.

Referring to FIG. 20, the consumption pattern classification unit 414 of the energy service provider 410 shown in FIG. 4 collects information regarding the power consumption pattern of each user (i.e., household) (operation S2010). For example, if there are one million households in a certain area, electric power consumed by each household may be checked at regular intervals (e.g., every six minutes). In this case, changes in the checked power consumption of each household may be used as power consumption pattern information. The consumption pattern classification unit 414 groups users (households) who show similar power consumption patterns during a day, based on the collected power consumption pattern information (operation S2020).

Then, power consumption patterns that can represent the power consumption patterns of the grouped users may be obtained by using a geometrical or statistical method (operation S2030). Here, various conventional techniques may be used as the geometrical or statistical method.

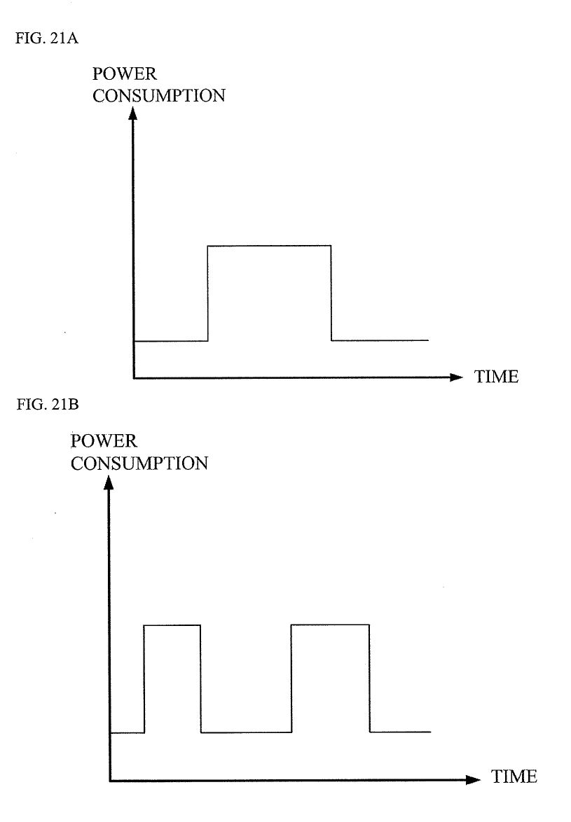

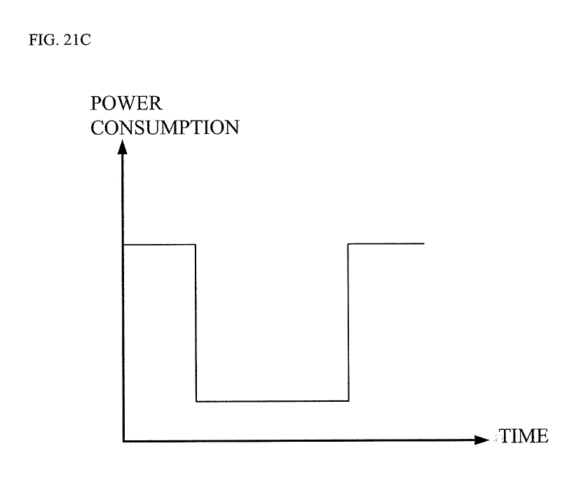

A number of consumption patterns may be obtained by using the geometrical or statistical method. For example, if three representative consumption patterns illustrated in FIGS. 21A through 21C are obtained, the power consumption patterns of the one million users (i.e., households) may be grouped into the three representative consumption patterns.

Therefore, the consumption pattern classification unit 414 determines which of the three representative consumption patterns the power consumption pattern of each of the one million users corresponds and informs the critical peak determination unit 416 of the determination result (operation S2040). The demand response unit 418 may manage information regarding the representative consumption pattern determined for each user (household).

If ten users (households) are added to the certain area, the consumption pattern classification unit 414 informs the critical peak determination unit 416 or the demand response unit 418 of the representative consumption pattern of each of the ten users when it can identify the representative consumption pattern of each of the ten users. If the consumption pattern classification unit 414 cannot identify the representative consumption pattern of each of the ten users, it temporarily determines an arbitrary representative consumption pattern for each of the ten users. Then, the consumption pattern classification unit 414 checks the power consumption pattern of each of the ten users (i.e., households) at regular time intervals (e.g., every five minutes) everyday for a predetermined period of time and finds out which of the three representative consumption patterns the power consumption pattern of each of the ten users corresponds.

The form of the representative consumption pattern and the number of representative consumption patterns may not be limited to a certain form or a certain number and may change anytime according to the number of users (households) or the pricing policy of the energy service provider 410.

According to the Detailed Description of the Invention, the consumption pattern classification unit 414 checks the power consumption pattern of each user. However, the present invention is not limited thereto. That is, the energy service provider 410 may include an additional component that checks the power consumption patterns of all users (households) in a certain area and determines representative consumption patterns. In addition, the consumption pattern classification unit 414 may determine which of preset representative consumption patterns the power consumption pattern of each user (household) added to the certain area corresponds and classify the power consumption pattern of each additional user (household) based on the determination result.

The representative consumption patterns may be updated at regular intervals (e.g., on a quarterly or yearly basis).

The price estimation unit 412 of the energy service provider 410 estimates an electricity price by using various price estimation techniques described above. The critical peak determination unit 416 reflects the consumption pattern information of each user in the estimated electricity price (operation S2050).

More specifically, each user's (household's) hourly power usage, which can be identified from his or her power consumption pattern, may be reflected in the estimated electricity price as a weight. In this case, an electricity price during a period of high power demand may be relatively high, whereas an electricity price during a period of low power demand may be relatively low.

If the power consumption pattern of each user (household) is reflected in the estimated electricity price as described above, the energy service provider 410 can find a CPP time section more effectively.

According to a method of determining a CPP time section in a conventional CPP program, an electricity price to be determined in an electricity market is estimated, and a swing option is applied to the estimated electricity price.

As used herein, the swing option denotes an option that is generally traded in an energy market. Unlike a general option, the swing option can be exercised a number of times, and the amount of goods, which can be traded with the swing option, may be flexible within a predetermined range. That is, in the present invention, the method of determining a CPP time section with restrictions may be conceptually similar to swing option valuation (that is, when the swing option should be exercised to obtain biggest gains). Since a method of applying the swing option to an estimated electricity price is widely known, a detailed description thereof will be omitted.

In the conventional art, a CPP time section is determined by applying the swing option to an electricity price estimated by the price estimation unit 412 of the energy service provider 410. However, in the present invention, the electricity price estimated by the price estimation unit 412 is updated in consideration of the power consumption pattern of each user, and the swing option is applied to the updated electricity price to determine the CPP time section (operation S2060). Consequently, in the present invention, the energy service provider 410 can find a CPP time section that will deliver bigger gains to the energy service provider 410.

In demand response described above, both a power supplier and a user can enjoy benefits of a more efficient CCP program.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A household demand response apparatus comprising:
a signal reception unit which receives a critical peak notification message;
a display unit which displays the received critical peak notification message and displays an inquiry message inquiring whether to interrupt power supply during a time section in which a critical peak occurs; and
a control unit which controls the power supply based on a response to the inquiry message.

2. The apparatus of claim 1, wherein the critical peak notification message is determined based on a power consumption pattern and price volatility in a wholesale electricity market.

3. The apparatus of claim 1, wherein the critical peak notification message is displayed a predetermined number of times during a predetermined period of time.

4. The apparatus of claim 1, further comprising a storage unit which stores a power supply reservation made for the time section, wherein the control unit controls the power supply during the time section based on the stored power supply reservation.

5. The apparatus of claim 1, further comprising a user input unit which provides a medium by which a user can input the response.

6. The apparatus of claim 1, wherein, when the user fails to input the response, the control unit interrupts the power supply during the time section.

7. A demand response method comprising:
displaying a critical peak notification message;
displaying an inquiry message inquiring whether to interrupt power supply during a time section in which a critical peak occurs; and
controlling the power supply based on a response to the inquiry message.

8. The method of claim 7, wherein the critical peak notification message is determined based on a power consumption pattern and price volatility in a wholesale electricity market.

9. The method of claim 7, wherein the critical peak notification message is displayed a predetermined number of times during a predetermined period of time.

10. The method of claim 7, wherein the controlling of the power supply comprises, if a power supply reservation made for the time section is available, controlling the power supply during the time section based on the power supply reservation made for the time section.

11. The method of claim 7, wherein a user directly inputs the response.

12. The method of claim 7, wherein, when the user fails to input the response, the controlling of the power supply comprises interrupting the power supply during the time section.

13. An energy service provider system comprising:
a price estimation unit which estimates an electricity price to be determined in an electricity market;
a consumption pattern classification unit which provides power consumption pattern information of each user;
a critical peak determination unit which determines an electricity price and when to generate a critical peak pricing (CPP) event based on the estimated electricity price and the provided power consumption pattern information; and
a demand response unit which transmits a CPP event signal based on the determination result of the critical peak determination unit.

14. A demand response system comprising:
an energy service provider who transmits a CPP event signal based on a power consumption pattern of a user; and
a household demand response apparatus which receives the CPP event signal, displays details of a CPP event, and controls power supply during a time section, in which a CPP rate is applied, based on the user's response.
